(19) United States
(12) Patent Application Publication
(10) Pub. No.: US 2017/0196160 A1
(43) Pub. Date: Jul. 13, 2017

(54) AGRICULTURAL GROUND PENETRATING TOOL SENSOR SYSTEM

(71) Applicant: Precision Ag 360, Inc., Hancock, MN (US)

(72) Inventors: Adam D. Bjerketvedt, Hancock, MN (US); Brent D. Schaefer, Hancock, MN (US)

(73) Assignee: Precision Ag 360, Inc., Hancock, MN (US)

(21) Appl. No.: 15/390,187

(22) Filed: Dec. 23, 2016

Related U.S. Application Data
(60) Provisional application No. 62/278,064, filed on Jan. 13, 2016.

(51) Int. Cl. A01B 61/04; A01B 76/00; G01D 5/14; A01B 15/02

(52) U.S. Cl. CPC A01B 61/042; A01B 15/02; A01B 61/044; A01B 76/00; G01D 5/145

(57) ABSTRACT

A monitoring system for an agricultural tool includes a plate coupled within the agricultural tool. A shank is pivotably connected to the plate via a pivot bolt extending through the plate and shank. A first sensor device is coupled to the shank and a second sensor device is coupled the plate and aligned with the first sensor device when the shank is in a ripping position. An alarm is configured to notify when the shank is changed to a pivoted position such that the first and second sensor devices are no longer aligned

### CROSS REFERENCE TO RELATED APPLICATION

This Non-Provisional Patent Application claims the benefit of the filing date of U.S. Provisional Patent Application Ser. No. 62/278,064, filed Jan. 13, 2016, entitled “SHANK ALERT,” which is herein incorporated by reference.

### BACKGROUND

The preparation of agricultural fields for planting crops can involve conditioning the soil to optimize soil density and nutrients for plant growth. The soil conditioning process often involves the use of a tractor-towed implement configured with ground penetrating tools that break up and aerate the soil and inject fertilizer into the soil. Examples of such implements include cultivators, tillers, rippers, chisel plows, anhydrous knife fertilizers, and manure injectors, in which a plurality of one or more tools, such as discs and/or shanks are mounted on a tool bar of the implement. The shanks of such implements are designed to penetrate into the soil, which exposes them to underground obstacles. To minimize damage from such obstacles, shanks are typically pivotally mounted to the implement with a pivot bolt, and secured from pivoting by a shear bolt that is spaced from the pivot bolt. If an obstacle of considerable size is encountered, the shear bolt minimizes the risk of damage to the shank by shearing thereby allowing the shank to pivot up and away from the obstacle. Over time, shear pins can become fatigued and eventually fail due to the soil conditions encountered by the shank. An operator may not and often does not detect a broken shear pin until well after the event that caused the pin to shear, which results in potentially a significant area of soil that has not been conditioned. This can have considerable impact on crop yields, due to poor soil preparation and/or fertilizing, or can have a considerable impact on fuel costs to re-work the portions of the field where the shank was inoperative. A system for detecting and notifying an operator that a shank has pivoted away from its ground penetrating position would be beneficial.

### BRIEF DESCRIPTION OF THE DRAWINGS

FIG. 1 illustrates a side view of an agricultural tool with a monitoring system in accordance with one embodiment.

FIG. 2 illustrates an end view of an agricultural tool with a monitoring system in accordance with one embodiment.

FIG. 3 illustrates a side view of an agricultural tool with a monitoring system in accordance with one embodiment.

FIG. 4 illustrates an end view of an agricultural tool with a monitoring system in accordance with one embodiment.

FIG. 5 illustrates a side view of an agricultural tool with a monitoring system in accordance with one embodiment.

FIG. 6 illustrates a perspective view of a protective sleeve for an agricultural tool in accordance with one embodiment.

FIG. 7 illustrates a protective sleeve mounted over a portion of a frame of an agricultural tool in accordance with one embodiment.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the invention can be positioned in a number of different orientations, the directional terminology is used for purposes of illustration and is in no way limiting. It is to be understood that other embodiments may be utilized and structural or logical changes may be made without departing from the scope of the invention. The following detailed description, therefore, is not to be taken in a limiting sense, and the scope of the invention is defined by the appended claims.

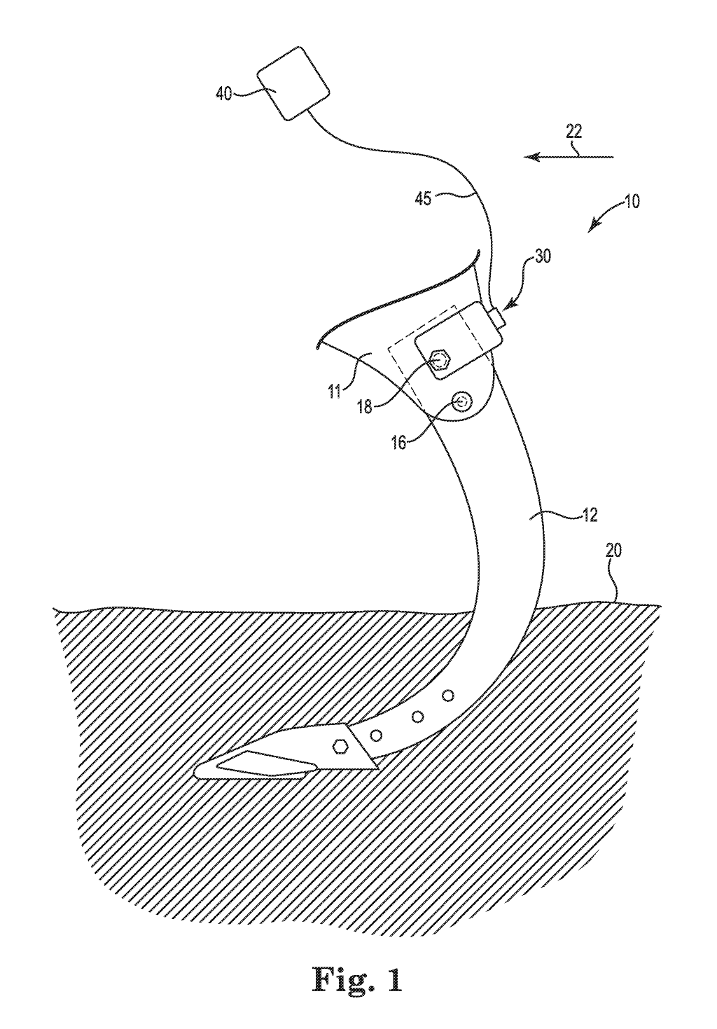

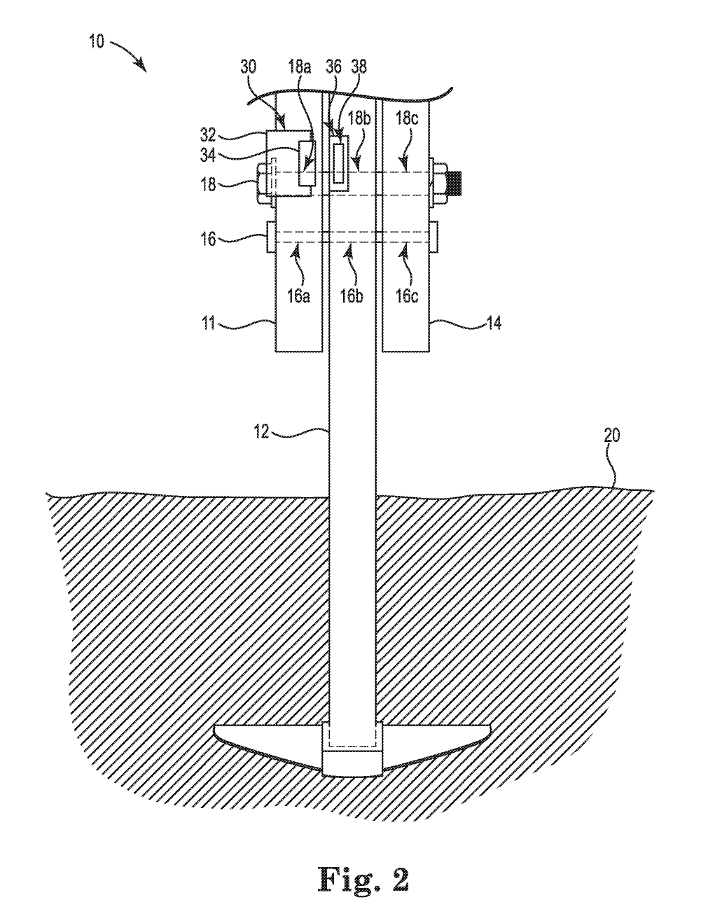

FIGS. 1 and 2 illustrate respective side and end views of an agricultural tool 10 with a monitoring system 30 in accordance with one embodiment. In one embodiment, agricultural tool 10 is a tractor-towed implement configured with ground penetrating tools that break up and aerate the soil and inject fertilizer into the soil. Such systems include tillage, or fertilizer (manure or commercial or anhydrous) systems, such as a cultivator, tiller, ripper, chisel plow, anhydrous knife fertilizer, strip till, or manure injector. Examples of such equipment include, but are not limited to, Wilrich soil pro 513, Wilrich 2530, Landluvr strip till attachments, Yetter strip till attachment, Kuhn 4830, Kuhn Dominator 4855, Great Plains Ripper, Case 5300 Strip rig, Bingham, Dietrich series 70 auto reset, and slurry injectors.

In one embodiment, agricultural tool 10 includes a first plate 11 and second plate 14 (not visible in FIG. 1; illustrated in FIG. 2) that are part of, or coupled to, a tool bar of the implement to be towed by a tractor or the like. Typically, the plates will be coupled to a tool bar in conjunction with springs that provide some shock absorption for the agricultural tool 10 so that it can flex as there is impact with objects on the ground 20.

Agricultural tool 10 further includes a shank 12, which is coupled to first and second plates 11 and 14, and is configured for penetration into the ground 20 to be tilled. Shank 12 is pivotably coupled to first and second plates 11/14 via pivot bolt 18. Shank 12 is prevented from pivoting relative to plates 11/14, however, when shear bolt 16 is installed extending through each of plates 11/14 and through shank 12. In one embodiment, agricultural tool 10 may include several such shanks that are spaced from one another on a tool bar that can extend the width of a tractor or greater.

Agricultural tool 10 further includes monitoring system 30 in accordance with one embodiment. In one embodiment, monitoring system 30 includes plate mounting bracket 32, sensor 34, shank bracket 36 and sensor target 38. In one embodiment, plate mounting bracket 32 is coupled to first plate 11, such as via pivot bolt 18, or by other bolts, or by welding or similar means. Sensor 34 is fixed to plate mounting bracket 32 such that it is configured in close proximity to shank 12, shank bracket 36 and sensor target 38. In one embodiment, bracket 36 is fixed to a top surface of shank 12 and sensor target 38 is couple to bracket 36 such that it is held in close proximity to sensor 34.

In one embodiment, sensor target 38 is in communication with an alarm 40 that can be locate near the operator of the tractor or vehicle that is pulling agricultural tool 10. For example, sensor target 38 can be hard wired to an alarm 40 that is in a tractor cab. Alternatively, sensor target 38 can be wirelessly coupled to such an alarm 40, such as by RF communication. In one embodiment, sensor 34 is a proximity sensor and sensor target 38 is a magnet. As long as sensor target 38 is in close proximity to sensor 34, a signal will be sent to the alarm 40 that is indicative of shank 12 being properly oriented to penetrate the ground 20.

In operation, agricultural tool 10 is pulled, by a tractor or the like, in direction 22 over ground 20. Shank 12, illustrated in FIGS. 1 and 2 below the surface, penetrates and rips into ground 20 and agitates the soil. Shank 12 is held in this ripping position at least in part by shear bolt 16. FIG. 2 illustrates, in phantom lines, how shear bolt 16 extends through first plate 11 via hole 16a, through shank 12 via hole 16b and through second plate 14 via hole 16c. In some instances, when shank 12 encounters an obstacle in ground 20, such as a stump, rock or other impediment or obstacle, the springs provided on agricultural tool 10 allow shank 12 to move away from the obstacle and continue tilling. In other instances, however, the force of the impact of the obstacle on the shank 12 may be too much for the springs to absorb, and the force may cause shank 12 to shear off or break shear bolt 16, thereby allowing shank 12 to pivot up away from the obstacle and ground 20 by pivoting about pivot bolt 18. While this may prevent damage to shank 12 by the obstacle, it also prevents the shank 12 from properly agitating the soil as agricultural tool 10 continues along.

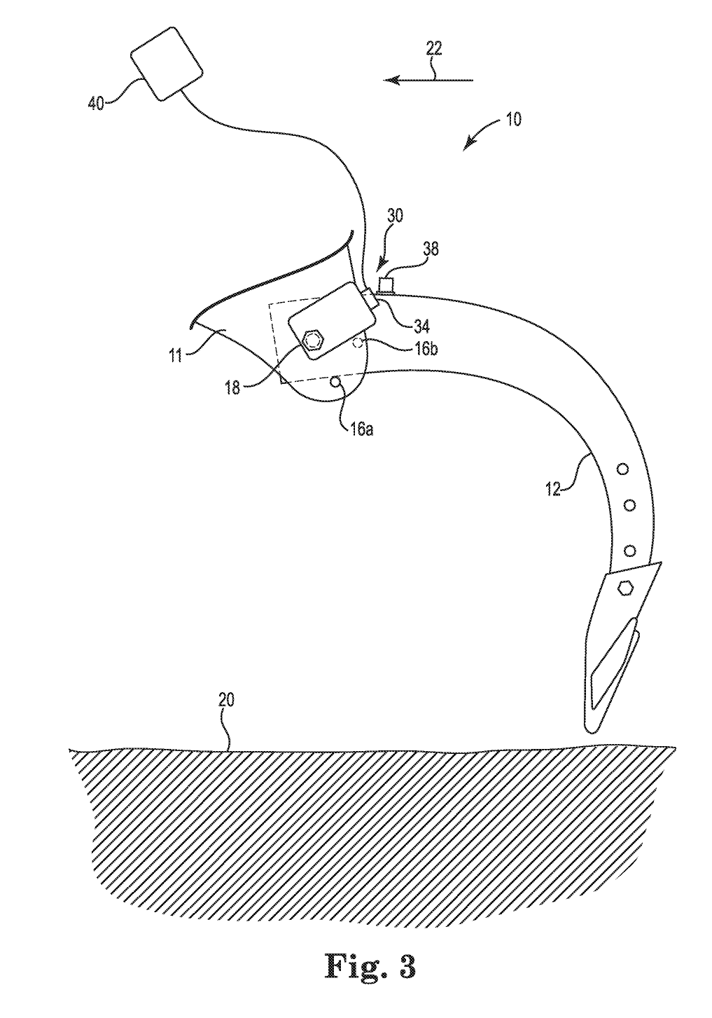

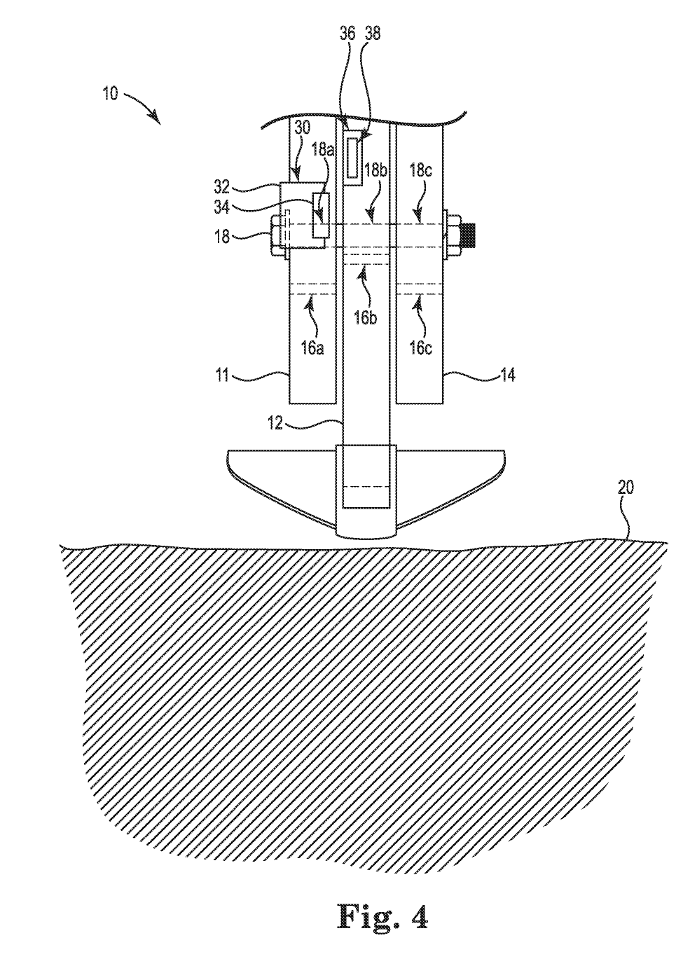

FIGS. 3 and 4 illustrate respective side and end views of an agricultural tool 10 with a monitoring system 30, in accordance with one embodiment, when shank 12 has pivoted into the illustrated pivoted position, such as when it has encountered an obstacle. In such case, shear bolt 16 has been sheared away leaving holes 16a/b/c open allowing shank to pivot about pivot bolt 18, which is illustrates in FIG. 4 in phantom lines passing through holes 18a/b/c of first plate 11, shank 12 and second plate 14, respectively.

As also illustrated in FIGS. 3 and 4, as shank 12 pivots away from the ground 20 and obstacle, sensor target 38, which is coupled to shank 12, also moves away from sensor 34, which remains fixed to first plate 11. In this case, sensor 34 sends a signal to the alarm 40 that indicates the shank 12 has been rotated into the pivoted position, thereby notifying the operator that shank 12 is no longer in ripping position. In one embodiment, alarm 40 is a visual signal to alert an operator that a shank 12 has rotated away from the ground into the pivoted position; in another embodiment, an audio signal is sent; in another embodiment, a vibration is activated, and in other embodiments, various combinations of these warnings are activated in alarm 40.

In one embodiment, sensor 34 and sensor target 38 are located toward the back of agricultural tool 10, relative to the direction of tow 22. To generate a notification signal to alarm 40 that there has been a change of position and shank 12 is no longer in ripping position, sensor target 38 must rotate away from sensor 34. In order for the two to sufficiently separate, sensor 34 and sensor target 38 should be located far enough away from pivot bolt 18 such that the upward pivot of shank 12, on which sensor target 38 is mounted, moves sensor target 38 far enough away from sensor 34 to generate the position-change signal. If sensor 34 and sensor target 38 are mounted directly above pivot bolt 18, it is possible the sensor 34 and sensor target 38 will remain too close together, even when shank 12 has pivoted out of the ground 20, such that no signal will be generated to notify the operator of the position change. In one embodiment, sensor 34 and sensor target 38 are located closer to shear bolt 16 than to pivot bolt 16 in order to ensure adequate relative movement of sensor 34 and sensor target 38. In another embodiment, sensor 34 and sensor target 38 are located essentially above shear bolt 16 in order to ensure that a signal will be sent to alarm 40 whenever shank 12 pivots upward.

In one embodiment, sensor 34 is coupled to either first or second plate 11/14, while sensor target 38 is coupled to shank 12. Because neither first nor second plate 11/14 rotate upon the shearing of shear pin 16, it may be useful in some embodiments, such as where sensor 34 is hard-wired to alarm 40, to have sensor 34 coupled to either first or second plate 11/14. In this way, there are no moving parts that would risk damage to the wired connection between sensor 34 and alarm 40. In one embodiment, such as when sensor target 38 is a magnet, even though it does rotate with shank 12, sensor target 38 is not coupled back to, or in direct communication with, the alarm 40. As such, even though sensor target 38 is coupled to the moving shank 12, it is less likely that the harsh environment, significant impact and vibration to which shank 12 is subjected will cause disruption to the proper operation of alarm 40.

In one embodiment, sensor 34 is a Hall-effect sensor, which is a transducer that varies its output voltage in response to a magnetic field, such as that of a magnet target 38. Such Hall-effect sensors have been proven to be quite reliable in the harsh conditions to which agricultural tool 10 is subjected. In other embodiments, various other devices can be used for sensor 34 and sensor target 38. For example, optical sensor devices can be used. In one embodiment, sensor 34 can be an optical sensor and sensor target 38 can be a light source. In another embodiment, sensor 34 can be a whisker switch and sensor target 38 may not be needed, and the whisker switch can instead directly impact against shank 12, such that pivoting of shank 12 trips the whisker switch. Also, in some embodiments, sensor 34 and sensor target can be located differently, such that sensor 34 is mounted in shank 12 and sensor target 38 on first plate 11, or such that sensor 34 is mounted in second plate 14 and sensor target 38 on shank 12. In some embodiments, especially given the harsh environment in which agricultural tool 10 typically operates, it may be advantageous to have redundant sensors 34 mounted on each of first and second plates 11 and 14 with sensor target 38 mounted in shank 12. In this way, even where one of the redundant sensors fails, the non-failing sensor can signal alarm 40 of shank 12 position changes.

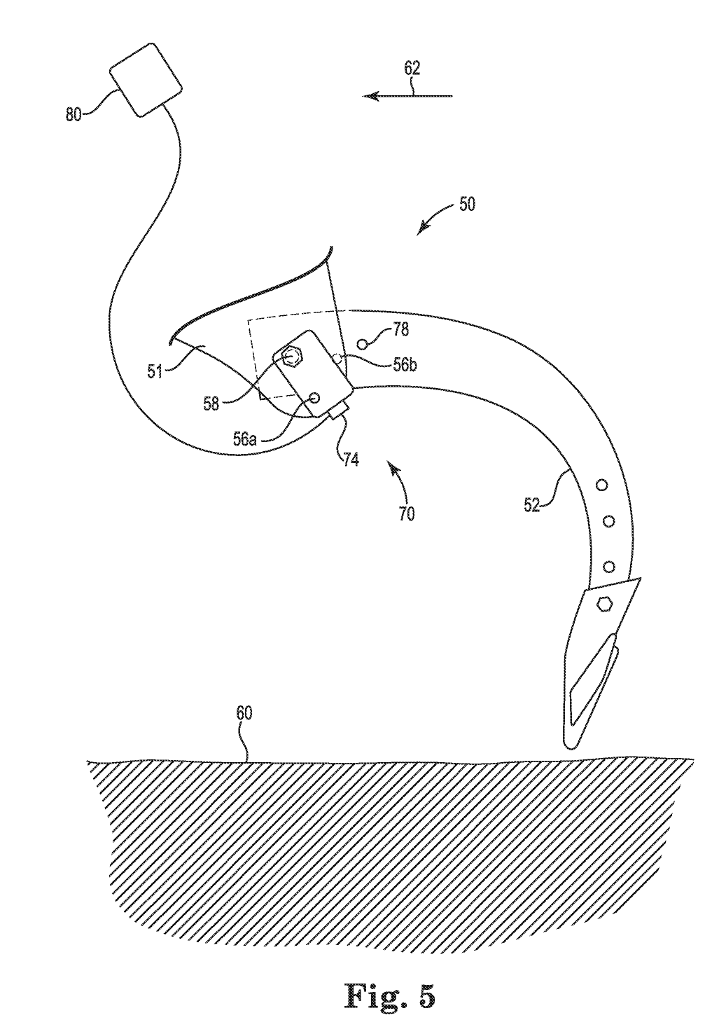

FIG. 5 illustrates a side view of an agricultural tool 50 with a monitoring system 70 in accordance with one embodiment. In one embodiment, agricultural tool 50 is similar to tool 10 above, and is a tractor-towed implement configured with ground penetrating tools. In one embodiment, agricultural tool 50 includes a first plate 51 and second plate 54 (not visible in FIG. 5) that are part of, or coupled to, a tool bar of the implement to be towed by a tractor or the like. Agricultural tool 50 further includes a shank 52, which is coupled to first and second plates 51 and 54, and is configured for penetration into the ground 60 to be tilled. Shank 52 is pivotably coupled to first and second plates 51/54 via pivot bolt 58. Shank 52 is prevented from pivoting relative to plates 51/54, however, when shear bolt 56 (which has been sheared away in FIG. 5) is installed extending through each of plates 51/54 and through shank 52.

In FIG. 5, shank 52 is illustrated in the pivoted position, such that shearing bolt 56 has been sheared away, leaving holes 56a in first plate 51 and 56b in shank 52 each open, and shank 52 is pivoted out of the ground 60. In one embodiment, while agricultural tool 50 is towed in direction 62 and shank 52 encountered an obstacle, shank 52 shears shear pin 56 and pivots up.

Similar to tool 10 above, agricultural tool 50 also includes a monitoring system 70 in accordance with one embodiment. In one embodiment, monitoring system 70 includes sensor 74, sensor target 78 and alarm 80. In one embodiment, plate mounting bracket 72 is coupled to first plate 51, such as via pivot bolt 58, or by other welding, bolts or similar means. Sensor 74 is fixed to plate mounting bracket 72 such that it is configured in close proximity to shank 52 and sensor target 78, when shank 52 is in the ripping position. In one embodiment, sensor target 78 is welded directly to shank 52. In another embodiment, sensor target 78 is embedded into shank 52, such as firmly mounted in a hole within shank 52. The location of sensor target 78 on or within shank 52 is configured to align with sensor 74 when shank 52 is generally aligned with first and second plates 51/54 and is penetrating the ground 60.

In operation of agricultural tool 50, as shank 52 pivots away from the ground 60 and an encountered obstacle, sensor target 78, which is coupled to shank 52, also moves away from sensor 74, which remains fixed to the end of first plate 51. In this case, sensor 74 sends a signal to the alarm 80 that indicates the shank 52 has been rotated into the pivoted position, thereby notifying the operator that shank 52 is no longer in ripping position. In one embodiment, alarm 80 is a visual signal to alert an operator that a shank 52 has rotated away from the ground into the pivoted position; in another embodiment, an audio signal is sent; in another embodiment, a vibration is activated, and in other embodiments, various combinations of these warnings are activated in alarm 80.

In one embodiment, sensor 74 is located on a lower edge of first plate 51. As agricultural tool 50 is towed in direction 62, shank 52 and various other agitating mechanisms attached to agricultural tool 50 cause significant dirt, mud, snow and various other debris to impact tool 50. Accordingly, locating sensor 74 on a lower edge surface, relative to the direction of tow 62, helps mitigate the impact such debris will have on sensor 74, at least partially shielding sensor 74 by plate 51. A similar protection can be afforded using a back surface of second plate 52 or other surface that is opposite to the direction of travel 62.

As discussed, agricultural tool 10 may include several shanks 12/52 that are spaced from one another on a tool bar that can extend the width of a tractor or greater. In one embodiment, a monitoring system 30/70 is provided for each shank 12/52. For example, if agricultural tool 10 has 24 shanks 12₁-12₂₄, each shank 12₁-12₂₄ includes a respective monitoring system 30₁-30₂₄. In addition, each such monitoring system 30₁-30₂₄ is individually coupled to alarm 40/80. In this way, alarm 40/80 not only identifies when a shank 12 has broken, but also identified which of the 24, in one example, has broken.

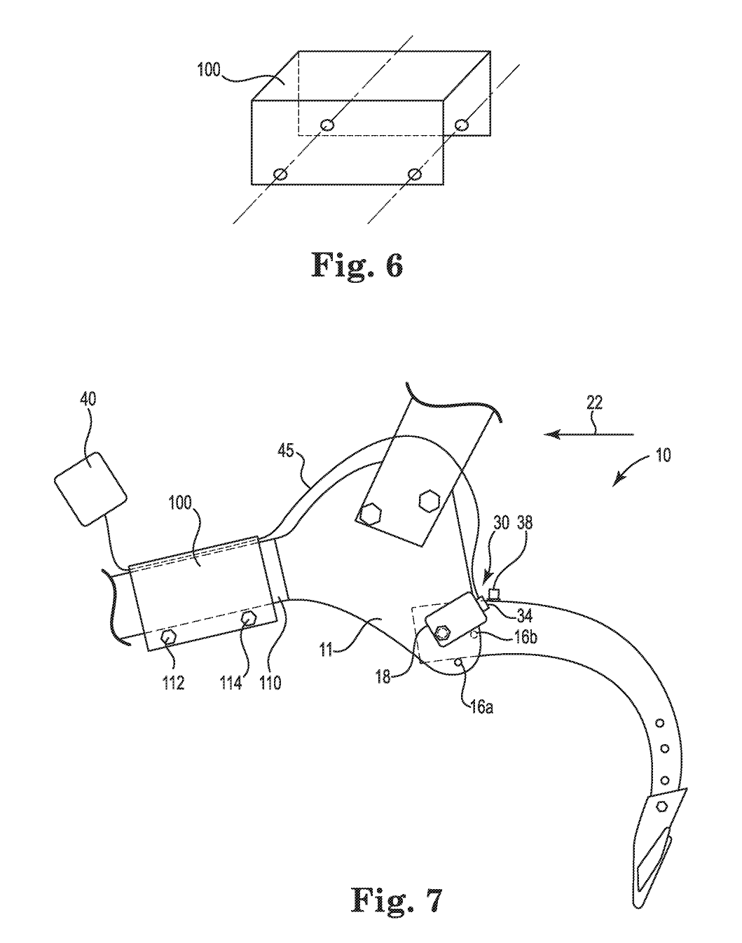

In one embodiment, agricultural tool 10 further includes protective sleeve 100 illustrated in FIG. 6. Because of the harsh environment in which agricultural tool 10 typically operates and because of the impact to which certain portions of tool 10 are subjected, protective sleeve 100 provides protection to wiring that is coupled between monitoring system 30/70 and alarm 40/80. Sleeve 100 can protect the wiring from being severed thereby ensuring the continued operation of monitoring system 30/70 and alarm 40/80.

FIG. 7 illustrates protective sleeve 100 assembled on agricultural tool 10 in accordance with one embodiment. As previously described, in one embodiment shank 12 is coupled to first and second plates 11 and 14. Furthermore, in one embodiment first and second plates 11 and 14 are coupled to a frame 110 of agricultural tool 10. Frame 110 is part of, or coupled to, a tool bar of the implement to be towed by a tractor or the like. Frame 110 is also configured to flex upward as shank 12 and other portions tool 10 impact the ground 20. In some instances, certain portions of frame 110 will impact against other parts of agricultural tool 10 as it moves. In such instances, wires 45, which are coupled between monitoring system 30 and alarm 40, are readily severed, thereby disabling the system.

Accordingly, protective sleeve 100 is assembled on agricultural tool 10, particularly on portions thereof that are likely to be subjected to impact with other parts of agricultural tool 10. Wiring 45 can then be fed between protective sleeve 100 and frame 110. In this way, when frame 110 impacts against other parts of agricultural tool 10 as it moves, such impact will be against protective sleeve 100, and wiring 45 is protected underneath. As such, monitoring system 30 and alarm 40 remain in communication and the system remains operational.

In some embodiments, the portion of frame 110 that is likely to be subjected to impact is substantially rectangular in shape. As such, in one embodiment protective sleeve 100 is substantially c-shaped such that it can be readily slid over the top of frame 110 without any required modification to frame 110. Then, securing bolts 112 and 114 can be slid through slots provided at the lower edge of the c-shaped protective sleeve 100, thereby securing it in place. Such a configuration is convenient in some embodiments, because it readily protects wiring 45 from damage, but does not require any modification to frame 110. It can be easily added to a variety of existing agricultural tools 10.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A monitoring system for an agricultural tool comprising:
a plate coupled within the agricultural tool;
a shank pivotably connected to the plate via a pivot bolt extending through the plate and shank;
a first sensor device coupled to the shank;
a second sensor device coupled the plate and aligned with the first sensor device when the shank is in a ripping position; and
an alarm coupled to at least one of the first and second sensors and configured provide notification when the shank is changed to a pivoted position such that the first and second sensor devices are no longer aligned.

2. The monitoring system of claim 1, wherein the first sensor device is a sensor target and the second sensor device is a proximity sensor.

3. The monitoring system of claim 1, wherein the first sensor device is a proximity sensor and the second sensor device is a sensor target.

4. The monitoring system of claim 3, wherein sensor target is a magnet.

5. The monitoring system of claim 1, wherein the first sensor device is an optical source and the second sensor device an optical sensor.

6. The monitoring system of claim 1, wherein the first sensor device is one of a Hall-effect sensor and a whisker switch.

7. The monitoring system of claim 1 further comprising a protective sleeve coupled over a frame portion of the agricultural tool, wherein wiring coupling between the first sensor device and the alarm passes between the protective sleeve and the frame portion.

8. The monitoring system of claim 1 further comprising:
a second plate substantially parallel to the first plate and oriented such that shank is at least in part between the first and second plates; and
a shear bolt spaced apart from the pivot bolt and coupled through the first and second plate and through the shank;
wherein the agricultural tool is configured to be towed over ground such that the shank penetrates and rips the ground at such that when the shank encounters an obstacle the shear bolt will shear off and the shank pivots away from the obstacle about the pivot bolt.

9. The monitoring system of claim 8, wherein the first and second sensor devices are located closer to the shear bolt than to the pivot bolt.

10. The monitoring system of claim 8, wherein the first and second sensor devices are located essentially above the shear bolt.

11. The monitoring system of claim 8, wherein at least one of the first and second sensor devices are located on a surface of the agricultural tool that is opposite to a direction of travel of the agricultural tool.

12. A monitoring system for an agricultural tool comprising:
a plate coupled within the agricultural tool;
a shank pivotably connected to the plate via a pivot bolt extending through the plate and shank, wherein the shank is in a ripping position when aligned with the plate;
a sensor coupled to one of the plate and the shank, the sensor configured to sense when the shank is no longer aligned with the plate and changed from the ripping position to a pivoted position; and
an alarm coupled to the sensor and configured to provide notification when the shank is changed from the ripping to the pivoted position.

13. The monitoring system of claim 12, wherein the sensor further comprises at least one of a sensor target, a proximity sensor, a magnet, an optical source, an optical sensor, a Hall-effect sensor and a whisker switch.

14. The agricultural tool of claim 12, wherein the sensor and the sensor target are located closer to the shear bolt than to the pivot bolt.

15. The agricultural tool of claim 12 further comprising a protective sleeve coupled over a frame portion of the agricultural tool, wherein wiring coupling between the sensor and the alarm passes between the protective sleeve and the frame portion.

16. A method of detecting a break in agricultural tool comprising:
providing at least one plate coupled within the agricultural tool;
providing a shank pivotably connected to the plate via a pivot bolt extending through the plate and shank;
providing a shear bolt spaced apart from the pivot bolt and coupled through the first plate and through the shank when the shank is in a ripping position;
providing a sensor coupled the plate;
providing a sensor target coupled to the shank and aligned with the sensor when the shank is in the ripping position; and
providing an alarm signal when the shear bolt is sheared thereby moving the shank to a pivoted position.

17. The method of claim 16 further comprising providing a plurality of shanks each pivotably connected to the plate and a plurality of pivot bolts, one corresponding to one of the plurality of shanks and each extending through the plate and one shank.

18. The method of claim 17 further comprising providing a plurality of shear bolts, one corresponding to each of the plurality of shanks, each shear bolt spaced apart from the corresponding pivot bolt and coupled through the plate and through one shank when the shank is in a ripping position.

19. The method of claim 18 further comprising providing an alarm signal when any one of the plurality of shear bolts is sheared thereby moving one shank to a pivoted position, wherein a unique alarm signal is given for each of the plurality of shear bolts so that the corresponding shank is identified.
